(19) United States
(12) Patent Application Publication
(10) Pub. No.: US 2023/0276336 A1
(43) Pub. Date: Aug. 31, 2023

(54) METHODS AND APPARATUSES FOR HANDLING A CONDITIONAL HANDOVER (CHO) EXECUTION CONDITION IN A NON TERRESTRIAL NETWORK (NTN) ENVIRONMENT

(71) Applicant: LENOVO (BEIJING) LIMITED, Beijing (CN)

(72) Inventors: Lianhai WU, Beijing (CN); Min Xu, Beijing (CN); Mingzeng DAI, Shanghai (CN); Hongmei LIU, Beijing (CN); Ran YUE, Beijing (CN)

(21) Appl. No.: 18/006,976

(22) PCT Filed: Jul. 28, 2020
(86) PCT No.: PCT/CN2020/105254

§ 371 Date: Jan. 26, 2023

(51) Int. Cl. H04W 36/36; H04W 76/20; H04W 56/00

(52) U.S. Cl. CPC H04W 36/362; H04W 76/20; H04W 56/0045; H04W 84/06

(57) ABSTRACT

Embodiments of the present application relate to methods and apparatuses for handling a conditional handover (CHO) condition in a non terrestrial network (NTN) environment. According to an embodiment of the present application, a method can include: receiving a radio resource control (RRC) reconfiguration message, wherein the RRC reconfiguration message includes CHO configuration information associated with one or more target candidate cells and a set of CHO execution conditions associated with the one or more target candidate cells; the condition can be based on a measurement result, a distance between a UE and a base station, an absolute time, a timer, a time advance, an elevation angle and the combination of them; evaluating one or more CHO execution conditions associated with each of the one or more target candidate cells; determining whether a CHO execution condition associated with a target candidate cell is satisfied; and in response to satisfying the CHO execution condition, performing a CHO procedure from a source cell to the target candidate cell.

### TECHNICAL FIELD

Embodiments of the present application generally relate to wireless communication technology, especially to methods and apparatuses for handling a conditional handover (CHO) execution condition in a non terrestrial network (NTN) environment.

### BACKGROUND

The NTN environment refers to networks or segments of networks, which use a spaceborne vehicle or an airborne vehicle for transmission. For example, a spaceborne vehicle includes a satellite, which may be a Low Earth Orbiting (LEO) satellite, a Medium Earth Orbiting (MEO) satellite, a Geostationary Earth Orbiting (GEO) satellite as well as a Highly Elliptical Orbiting (HEO) satellite. An airborne vehicle includes a High Altitude Platform (HAP) encompassing Unmanned Aircraft Systems (UAS) which includes Lighter than Air UAS (LTA), and a Heavier than Air UAS (HTA).

In 3rd Generation Partnership Project (3GPP), when a user equipment (UE) needs to perform a CHO procedure from a serving cell of a source base station (BS) (e.g., a source satellite BS) to a candidate cell of a candidate BS (e.g., a target satellite BS), details regarding how to handle a CHO execution condition in a NTN environment have not been discussed.

### SUMMARY

Some embodiments of the present application provide a method, which may be performed by a UE. The method includes: receiving a radio resource control (RRC) reconfiguration message, wherein the RRC reconfiguration message includes CHO configuration information associated with one or more target candidate cells and a set of parameters of CHO execution conditions associated with the one or more target candidate cells; evaluating one or more CHO execution conditions associated with each of the one or more target candidate cells; determining whether a CHO execution condition associated with a target candidate cell is satisfied; and in response to satisfying the CHO execution condition, performing a CHO procedure from a source cell to the target candidate cell.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

Some embodiments of the present application provide a method, which may be performed by a BS. The method includes: receiving a measurement report; and transmitting a RRC reconfiguration message, wherein the RRC reconfiguration message includes CHO configuration information associated with one or more target candidate cells and a set of parameters of CHO execution conditions associated with the one or more target candidate cells.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned further method performed by a BS.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary flowchart of an intra-AMF handover procedure in accordance with some embodiments of the present application;

FIG. 3 illustrates an exemplary flow chart of a method for a CHO procedure in accordance with some embodiments of the present application;

FIG. 4 illustrates an exemplary flow chart of a method for transmitting parameters of CHO execution conditions in accordance with some embodiments of the present application; and

FIG. 5 illustrates an exemplary block diagram of an apparatus according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

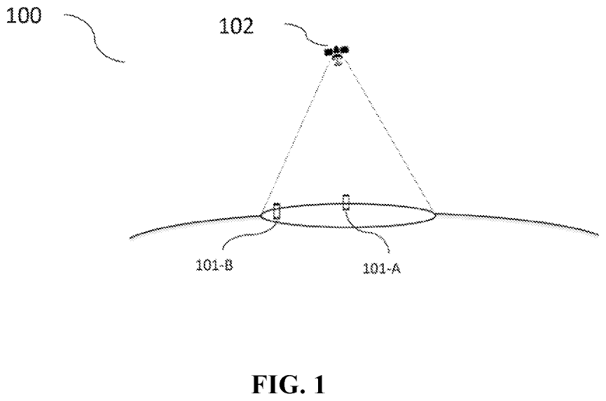

FIG. 1 illustrates a schematic diagram of a wireless communication system in accordance with some embodiments of the present application.

As shown in FIG. 1, the wireless communication system 100 includes two UEs, UE 101-A and UE 101-B, and a BS 102, for example, a satellite BS. Although merely one BS is illustrated in FIG. 1 for simplicity, it is contemplated that the wireless communication system 100 may include more BSs in some other embodiments of the present application. Similarly, although merely two UEs are illustrated in FIG. 1 for simplicity, it is contemplated that the wireless communication system 100 may include more UEs in some other embodiments of the present application. In the coverage of BS 102, UE 101-A is located at the nearest position to BS 102, that is, the distance between the position of UE 101-A and BS 102 is the smallest among all the positions in the coverage of BS 102, and UE 101-B is located at the farthest location to BS 102.

The BS 102 may also be referred to as an access point, an access terminal, a base, a macro cell, a node-B, an enhanced node B (eNB), a gNB, a home node-B, a relay node, or a device, or described using other terminology used in the art. The BS 102 is generally part of a radio access network that may include a controller communicably coupled to the BS 102.

The UE 101-A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A may include wearable devices, such as smart watches, fitness bands, optical head-mounted displays, or the like. Moreover, the UE 101-A may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP based network, a 3GPP 5G network, a satellite communications network, a high altitude platform network, and/or other communications networks.

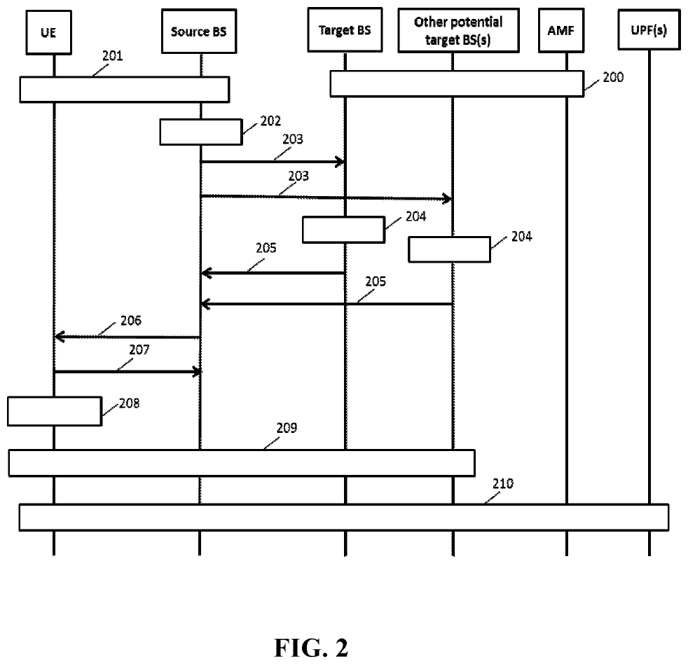

FIG. 2 illustrates an exemplary flowchart of an intra-AMF handover procedure in accordance with some embodiments of the present application. The embodiments of FIG. 2 depict a CHO procedure where neither an access and mobility management function (AMF) nor user plane functions (UPFs) changes.

Referring to FIG. 2, in step 200, an AMF provides mobility control information. The UE context within a source BS contains information regarding roaming and access restrictions which were provided either at a connection establishment or at the last timing advance (TA) update procedure.

In step 201, the source BS transmits measurement configuration information to a UE, and the UE reports a measurement result to the source BS based on the measurement configuration information. In step 202, the source BS may decide to configure a CHO configuration, which is based on the measurement result reported by the UE.

In step 203, the source BS transmits a Handover REQUEST message for conditional handover to one or more candidate target BSs, e.g., a target BS and other potential target BS(s) as shown in FIG. 2. For example, the Handover REQUEST message for conditional handover may pass a transparent RRC container with necessary information to prepare a CHO procedure at a target BS side.

In step 204, the one or more candidate target BSs perform admission control, to decide whether to allow the CHO procedure of the UE after receiving the Handover REQUEST message for conditional handover from the source BS.

In step 205, based on an admission control result, the one or more candidate target BSs may prepare handover resource(s) for the UE and send a handover REQUEST ACKNOWLEDGE message including CHO configuration of candidate cell(s) to the source BS.

In step 206, the source BS sends an RRCReconfiguration message, which contains CHO configuration information of candidate cell(s) and CHO execution condition(s), to the UE. In step 207, the UE sends an RRCReconfigurationComplete message to the source BS.

In step 208, the UE maintains a connection with the source BS after receiving the CHO configuration information, and starts evaluating CHO execution condition(s) for the CHO candidate cell(s). If the corresponding CHO execution condition associated with at least one CHO candidate cell is satisfied, the UE detaches from the source BS, applies the stored corresponding configuration information for this CHO candidate cell, synchronizes to this CHO candidate cell, and completes the CHO handover procedure.

In step 209, the UE sends a CHO handover completion message to the one or more candidate target BSs. In step 210, a data forwarding path switch procedure between all entities in FIG. 2 needs to be further studied. Any ongoing data forwarding may be continued.

According to some agreements of 3GPP standard documents, an execution condition for a CHO procedure in a NTN environment may include the following:
Measurement based trigger condition: configuration of trigger thresholds and/or which measurement events to be used as a trigger condition should consider the NTN environment, e.g., the small variation of the cell quality measured in a cell center and at a cell edge in the NTN environment.
Location based trigger condition: additional trigger conditions based on a UE's location and a satellite's location can be considered in the NTN environment. Location based CHO procedure in LEO scenarios should consider deterministic satellite movement. For example, the location based trigger condition may be expressed as a distance between the UE and the satellite.
Time(r) based trigger condition: this condition may be based on UTC time or a timer based solution. Time based CHO procedure in LEO scenarios should consider deterministic satellite movement.
Timing advance (TA) value based trigger condition: additional trigger conditions based on a timing advance value to the target cell can be considered in the NTN environment.
Elevation angles (EA) of source and target cells based trigger condition: additional trigger conditions based on elevation angles of a source cell and a target cell can be considered in the NTN environment.

As specified in 3GPP TS 38.331, a measurement based trigger condition includes the following two events, i.e., Event A3 and Event A5. In an assumption that a source cell is a master cell group or secondary cell group (SpCell), 3GPP TS 38.331 defines entering conditions and leaving conditions of Event A3 and Event A5, respectively.
Event A3: a neighbour cell becomes offset better than a SpCell.
Event A5: a SpCell becomes worse than one threshold and a neighbour cell becomes better than another threshold.

Currently, details regarding how to handle a CHO execution condition have not been discussed in a NTN environment. Some embodiments of the present application provide solutions for handling a CHO execution condition in a NTN environment.

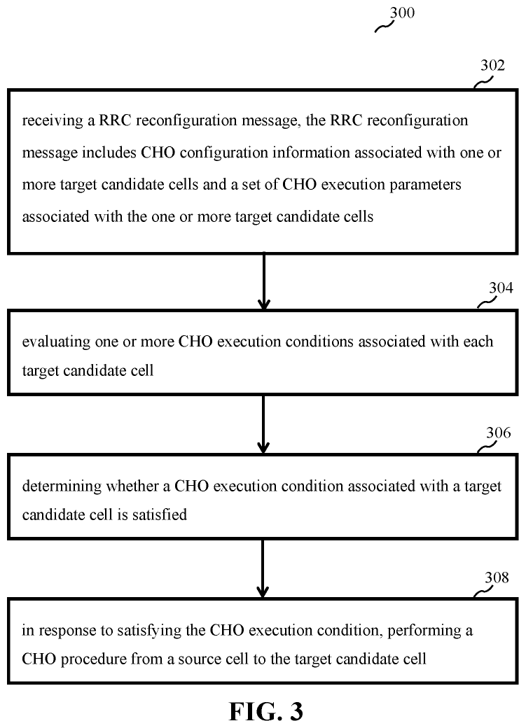

FIG. 3 illustrates an exemplary flow chart of a method for a CHO procedure in accordance with some embodiments of the present application. The embodiments of FIG. 3 may be performed by a UE (e.g., UE 101-A and UE 101-B illustrated and shown in FIG. 1). Although described with respect to a UE, it should be understood that other devices may be configured to perform a method similar to that of FIG. 3.

In the exemplary method 300 as shown in FIG. 3, in operation 302, a UE receives a RRC reconfiguration message. For example, the UE receives a RRC reconfiguration message from a BS (e.g., a BS 102 illustrated and shown in FIG. 1). The RRC reconfiguration message includes CHO configuration information associated with one or more target candidate cells. The RRC reconfiguration message also includes a set of parameters of CHO execution conditions associated with the one or more target candidate cells.

In operation 304, the UE evaluates one or more CHO execution conditions associated with each of the one or more target candidate cells. In operation 306, the UE determines whether a CHO execution condition associated with a target candidate cell is satisfied. For instance, the set of parameters of CHO execution conditions includes a timer to trigger (TTT). If duration time of satisfying an entering condition of the CHO execution condition is equal to or longer than the TTT (i.e., the entering condition of the CHO execution condition is fulfilled during the TTT), the UE determines that the CHO execution condition is satisfied.

In operation 308, if the CHO execution condition associated with the target candidate cell is satisfied, the UE performs a CHO procedure from a source cell to the target candidate cell. The source cell or the target candidate cell may be a NTN cell.

According to some embodiments, upon the UE successfully accessing to the target candidate cell, the UE may remove the CHO configuration information and the set of parameters of CHO execution conditions received in operation 302.

According to some embodiments, the UE receives a mapping table including one or more entries. Each entry of the mapping table may include at least one of:
a mapping association between “distance information of the UE” and “a timing advance (TA) value between the UE and the source cell”. The UE may calculate the distance information based on location information and ephemeris information of the UE; and
a mapping association between “the distance information of the UE” and “a TA value between the UE and the target candidate cell”.

In some embodiments of the subject application, a CHO execution condition associated with a target candidate cell comprises a location based trigger condition.

In an example, the location based trigger condition is a location based event that a distance between a UE and the source cell is offset greater than a distance between the UE and the target candidate cell. For short, this location based event may be named as Location based event 1.

In this example, the set of parameters of CHO execution conditions received by the UE in operation 302 may include a distance hysteresis parameter and a distance offset. The distance offset may be associated with “a measurement object of the UE” or “a satellite”. The distance offset is cell specific. For example, the distance offset is associated with a source cell of the UE.

Location based event 1 may include an entering condition of a CHO procedure (e.g., Entering condition #1 as described below), which may also be named as a distance entering condition or a location entering condition. In an embodiment, the entering condition is: a difference between “a distance between a UE and a source cell” (e.g., Dp as described below) and “a distance hysteresis parameter” (e.g., Hys1 as described below) is greater than a sum of “a distance between the UE and a target candidate cell” (e.g., Dn as described below) and “a distance offset” (e.g., offset1 as described below).

Location based event 1 may include a leaving condition of a CHO procedure (e.g., Leaving condition #1 as described below), which may also be named as a distance leaving condition or a location leaving condition. In an embodiment, the leaving condition is: a sum of “a distance between a UE and a source cell” (e.g., Dp as described below) and “a distance hysteresis parameter” (e.g., Hys1 as described below) is less than a sum of “a distance between the UE and a target candidate cell” (e.g., Dn as described below) and “a distance offset” (e.g., offset1 as described below).

The entering condition and the leaving condition of Location based event 1 in the abovementioned example may be represented by:
Entering condition #1: Dp−Hys1>Dn+offset1
Leaving condition #1: Dp+Hys1<Dn+offset1
i. Dp (Distance primary) is a distance between a UE and a source cell (e.g., a SpCell).
ii. Dn (Distance neighbour) is a distance between a UE and a target candidate cell (e.g., a neighbour cell).
iii. The offset1 is optional. The offset1 may be a parameter associated with “a measurement object of the UE” or “a satellite”. The offset1 is cell specific.
iv. Hys1 is a hysteresis parameter for Location based event 1.

In a further example, the location based trigger condition is a further location based event that: a distance between a UE and a source cell is greater than one distance threshold; and/or a distance between the UE and a target candidate cell is less than one further distance threshold. For short, this further location based event may be named as Location based event 2.

In this example, a set of parameters of CHO execution conditions received by the UE in operation 302 may include a distance hysteresis parameter and two distance thresholds. These two distance thresholds may be the same or different in different embodiments.

Location based event 2 may include two entering conditions of a CHO procedure (e.g., Entering condition #1-1 and Entering condition #1-2 as described below), which may also be named as distance entering conditions or location entering conditions. In an embodiment:
An entering condition is: a difference between “a distance between a UE and a source cell” (e.g., Dp as described below) and “a distance hysteresis parameter” (e.g., Hys2 as described below) is greater than a distance threshold (e.g., threshold1 as described below).
Another entering condition is: a sum of “a distance between a UE and a target candidate cell” (e.g., Dn as described below) and “a distance hysteresis parameter” (e.g., Hys2 as described below) is less than another distance threshold (e.g., threshold1′ as described below).

Location based event 2 may include two leaving conditions of a CHO procedure (e.g., Leaving condition #1-1 and Leaving condition #1-2 as described below), which may also be named as distance leaving conditions or location leaving conditions. In an embodiment:
A leaving condition is: a sum of “a distance between a UE and a source cell” (e.g., Dp as described below) and “the distance hysteresis parameter” (e.g., Hys2 as described below) is less than a distance threshold (e.g., threshold1 as described below).
Another leaving condition is: a difference between “a distance between a UE and a target candidate cell” (e.g., Dn as described below) and “the distance hysteresis parameter” (e.g., Hys2 as described below) is greater than another distance threshold (e.g., threshold1′ as described below).

The entering conditions and the leaving conditions of Location based event 2 in the abovementioned further example may be represented by:
Entering condition #1-1: Dp−Hys2>threshold1
Entering condition #1-2: Dn+Hys2<threshold1′
Leaving condition #1-1: Dp+Hys2<threshold1
Leaving condition #1-2: Dn−Hys2>threshold1′
i. Hys2 is a hysteresis parameter for Location based event 2.

Regarding a location based trigger condition, the UE may consider a location based event (e.g., Location based event 1 or Location based event 2) whose entering condition is satisfied during one TTT (e.g., TTT1) as “fulfilled”. The UE may consider a location based event whose leaving condition is satisfied during another TTT (e.g., TTT2) as “not fulfilled”. The length of TTT1 may be the same as or different from the length of TTT2. Namely, after an entering condition of a location based event (e.g., Location based event 1 or Location based event 2) is fulfilled during TTT1, the UE considers that the CHO execution condition has been “fulfilled” until a leaving condition of the location based event is fulfilled during TTT2. That is to say, once the leaving condition of the location based event is fulfilled during TTT2, the UE considers that the CHO execution condition is “not fulfilled”.

In some embodiments of the subject application, a CHO execution condition associated with a target candidate cell comprises a timing advance (TA) based trigger condition.

In an example, the TA based trigger condition is a TA based event that a TA value between a UE and a source cell is offset greater than a TA value between the UE and a target candidate cell. For short, this TA based event may be named as TA based event 1. For instance, a UE may obtain the TA value between a UE and a source cell or the TA value between the UE and a target candidate cell from a mapping table transmitted by a BS.

In this example, a set of parameters of CHO execution conditions received by the UE in operation 302 may include a TA hysteresis parameter and a TA offset. The TA offset may be associated with “a measurement object of the UE” or “a satellite”. The TA offset is cell specific. For example, the TA offset is associated with a source cell of the UE.

TA based event 1 may include an entering condition of a CHO procedure (e.g., Entering condition #2 as described below), which may also be named as a TA entering condition. In an embodiment, the entering condition is: a difference between “a TA value between a UE and a source cell” (e.g., TAp as described below) and “a TA hysteresis parameter” (e.g., Hys3 as described below) is greater than a sum of “a TA value between the UE and a target candidate cell” (e.g., TAn as described below) and “a TA offset” (e.g., offset2 as described below).

TA based event 1 may include a leaving condition of a CHO procedure (e.g., Leaving condition #2 as described below), which may also be named as a TA leaving condition. In an embodiment, the leaving condition is: a sum of “a TA value between a UE and a source cell” (e.g., TAp as described below) and “a TA hysteresis parameter” (e.g., Hys3 as described below) is less than a sum of “a TA value between the UE and a target candidate cell” (e.g., TAn as described below) and “a TA offset” (e.g., offset2 as described below).

The entering condition and the leaving condition of TA based event 1 in the abovementioned example may be represented by:
Entering condition #2: TAp−Hys3>TAn+offset2
Leaving condition #2: TAp+Hys3<TAn+offset2
i. TAp (TA primary) is a TA value between a UE and a source cell (e.g., a SpCell).
ii. TAn (TA neighbour) is a TA value between a UE and a target candidate cell (e.g., a neighbour cell).
iii. The offset2 is optional. The offset2 may be a parameter associated with “a measurement object of the UE” or “a satellite”. The offset2 is cell specific.
iv. Hys3 is a hysteresis parameter for TA based event 1.

In a further example, the TA based trigger condition is a further TA based event that: a TA value between a UE and a source cell is greater than one TA threshold; and/or a TA value between the UE and a target candidate cell is less than one further TA threshold. For short, this further TA based event may be named as TA based event 2.

For instance, a UE may obtain the TA value between a UE and a source cell or the TA value between the UE and a target candidate cell from a mapping table transmitted by a BS. In this example, a set of parameters of CHO execution conditions received by the UE in operation 302 may include a TA hysteresis parameter and two TA thresholds. These two TA thresholds may be the same or different in different embodiments.

TA based event 2 may include two entering conditions of a CHO procedure (e.g., Entering condition #2-1 and Entering condition #2-2 as described below), which may also be named as TA entering conditions. In an embodiment:
An entering condition is: a difference between “a TA value between a UE and a source cell” (e.g., TAp as described below) and “a TA hysteresis parameter” (e.g., Hys4 as described below) is greater than a TA threshold (e.g., threshold2 as described below).
Another entering condition is: a sum of “a TA value between a UE and a target candidate cell” (e.g., TAn as described below) and “a TA hysteresis parameter” (e.g., Hys4 as described below) is less than another TA threshold (e.g., threshold2′ as described below).

TA based event 2 may include two leaving conditions of a CHO procedure (e.g., Leaving condition #2-1 and Leaving condition #2-2 as described below), which may also be named as TA leaving conditions. In an embodiment:
A leaving condition is: a sum of “a TA value between a UE and a source cell” (e.g., TAp as described below) and “the TA hysteresis parameter” (e.g., Hys4 as described below) is less than a TA threshold (e.g., threshold2 as described below).
Another leaving condition is: a difference between “a TA value between a UE and a target candidate cell” (e.g., TAn as described below) and “the TA hysteresis parameter” (e.g., Hys4 as described below) is greater than another distance threshold (e.g., threshold2′ as described below).

The entering conditions and the leaving conditions of TA based event 2 in the abovementioned further example may be represented by:
Entering condition #2-1: TAp−Hys4>threshold2
Entering condition #2-2: TAn+Hys4<threshold2′
Leaving condition #2-1: TAp+Hys4<threshold2
Leaving condition #2-2: TAn−Hys4>threshold2′
i. Hys4 is a hysteresis parameter for TA based event 2.

Regarding a TA based trigger condition, the UE may consider a TA based event whose entering condition is satisfied during one TTT (e.g., TTT1) as “fulfilled”. The UE may consider a TA based event whose leaving condition is satisfied during another TTT (e.g., TTT2) as “not fulfilled”. The length of TTT1 may be the same as or different from the length of TTT2. Namely, after the entering condition of a TA based event (e.g., TA based event 1 or TA based event 2) is fulfilled during TTT1, the UE considers that the CHO execution condition has been “fulfilled” until a leaving condition of the TA based event is “fulfilled” during TTT2. That is to say, once the leaving condition of the TA based event is fulfilled during TTT2, the UE considers that the CHO execution condition is “not fulfilled”.

In some embodiments of the subject application, a CHO execution condition associated with a target candidate cell comprises an elevation angle (EA) based trigger condition.

In an example, the EA based trigger condition is an EA based event that an EA between a UE and a source cell is offset greater than an EA between the UE and a target candidate cell. For short, this EA based event may be named as EA based event 1.

In this example, a set of parameters of CHO execution conditions received by the UE in operation 302 may include an EA hysteresis parameter and an EA offset. The EA offset may be associated with “a measurement object of the UE” or “a satellite”. The EA offset is cell specific. For example, the EA offset is associated with a source cell of the UE.

EA based event 1 may include an entering condition of a CHO procedure (e.g., Entering condition #3 as described below), which may also be named as an EA entering condition. In an embodiment, the entering condition is: a difference between “an EA between a UE and a source cell” (e.g., EAp as described below) and “an EA hysteresis parameter” (e.g., Hys5 as described below) is greater than a sum of “an EA between the UE and a target candidate cell” (e.g., EAn as described below) and “an EA offset” (e.g., offset3 as described below).

EA based event 1 may include a leaving condition of a CHO procedure (e.g., Leaving condition #3 as described below), which may also be named as an EA leaving condition. In an embodiment, the leaving condition is: a sum of “an EA between a UE and a source cell” (e.g., EAp as described below) and “a TA hysteresis parameter” (e.g., Hys5 as described below) is less than a sum of “an EA between the UE and a target candidate cell” (e.g., EAn as described below) and “an EA offset” (e.g., offset3 as described below).

The entering condition and the leaving condition of EA based event 1 in the abovementioned example may be represented by:
Entering condition #3: EAp−Hys5>EAn+offset3
Leaving condition #3: EAp+Hys5<EAn+offset3
i. EAp (EA primary) is an EA between a UE and a source cell (e.g., a SpCell).
ii. EAn (EA neighbour) is an EA between a UE and a target candidate cell (e.g., a neighbour cell).
iii. The offset3 is optional. The offset3 may be a parameter associated with “a measurement object of the UE” or “a satellite”. The offset3 is cell specific.
iv. Hys5 is a hysteresis parameter for EA based event 1.

In a further example, the EA based trigger condition is a further EA based event that: an EA value between a UE and a source cell is greater than one EA threshold; and/or an EA between the UE and a target candidate cell is less than one further EA threshold. For short, this further EA based event may be named as EA based event 2. In this example, a set of parameters of CHO execution conditions received by the UE in operation 302 may include an EA hysteresis parameter and two EA thresholds. These two EA thresholds may be the same or different in different embodiments.

EA based event 2 may include two entering conditions of a CHO procedure (e.g., Entering condition #3-1 and Entering condition #3-2 as described below), which may also be named as EA entering conditions. In an embodiment:
An entering condition is: a difference between “an EA between a UE and a source cell” (e.g., EAp as described below) and “an EA hysteresis parameter” (e.g., Hys6 as described below) is greater than an EA threshold (e.g., threshold3 as described below).
Another entering condition is: a sum of “an EA between a UE and a target candidate cell” (e.g., EAn as described below) and “an EA hysteresis parameter” (e.g., Hys6 as described below) is less than another EA threshold (e.g., threshold3′ as described below).

EA based event 2 may include two leaving conditions of a CHO procedure (e.g., Leaving condition #3-1 and Leaving condition #3-2 as described below), which may also be named as EA leaving conditions. In an embodiment:
A leaving condition is: a sum of “an EA between a UE and a source cell” (e.g., EAp as described below) and “an EA hysteresis parameter” (e.g., Hys6 as described below) is less than an EA threshold (e.g., threshold3 as described below).
Another leaving condition is: a difference between “an EA value between a UE and a target candidate cell” (e.g., EAn as described below) and “an EA hysteresis parameter” (e.g., Hys6 as described below) is greater than another EA threshold (e.g., threshold3′ as described below).

The entering conditions and the leaving conditions of EA based event 2 in the abovementioned further example may be represented by:
Entering condition #3-1: EAp−Hys6>threshold3
Entering condition #3-2: EAn+Hys6<threshold3′
Leaving condition #3-1: EAp+Hys6<threshold3
Leaving condition #3-2: EAn−Hys6>threshold3′
i. Hys6 is a hysteresis parameter for EA based event 2.

Regarding an EA based trigger condition, the UE may consider an EA based event whose entering condition is satisfied during one TTT (e.g., TTT1) as fulfilled. The UE may consider an EA based event whose leaving condition is satisfied during another TTT (e.g., TTT2) as not fulfilled. The length of TTT1 may be the same as or different from the length of TTT2. Namely, after an entering condition of an EA based event (e.g., EA based event 1 or EA based event 2) is fulfilled during TTT1, the UE considers that the CHO execution condition has been “fulfilled” until the leaving condition of the EA based event is fulfilled during TTT2. That is to say, once the leaving condition of the EA based event is fulfilled during TTT2, the UE considers that the CHO execution condition is “not fulfilled”.

In some embodiments of the subject application, a CHO execution condition associated with a target candidate cell comprises a measurement based trigger condition of a CHO procedure, i.e., Event A3 or Event A5 as specified in 3GPP TS 38.331.

Combination Manner 1

In some embodiments of the subject application, a CHO execution condition associated with a target candidate cell may be a combination of a measurement based trigger condition and a location based trigger condition. For instance, the CHO execution condition associated with the target candidate cell may be named as “the combined CHO trigger condition” and may be one of:
A combination of Event A3 and Location based event 1.
A combination of Event A3 and Location based event 2.
A combination of Event A5 and Location based event 1.
A combination of Event A5 and Location based event 2.

In these embodiments, a set of parameters of CHO execution conditions received in operation 302 may include a TTT. In particular, if duration time of satisfying an entering condition of Location based event 1 is equal to or longer than the TTT and duration time of satisfying an entering condition of Event A3 or Event A5 is equal to or longer than the TTT, the UE may determine that the combined CHO execution condition is satisfied. If duration time of satisfying an entering condition of Location based event 2 is equal to or longer than the TTT and duration time of satisfying an entering condition of Event A3 or Event A5 is equal to or longer than the TTT, the UE may determine that the combined CHO execution condition is satisfied.

In Option 1, a UE considers an event whose entering condition is satisfied during a TTT as “fulfilled” and considers an event whose leaving condition is satisfied during the TTT as “not fulfilled”. That is to say, only when both events in the combined CHO trigger condition are fulfilled, the UE starts a CHO procedure. If a measurement based event is fulfilled and a location based event is also fulfilled, the UE considers the target candidate cell as a triggered cell.

In some examples of Option 1, the UE may determine that the CHO execution condition is not satisfied, in each of the following cases:
duration time of satisfying a leaving condition of Location based event 1 is equal to or longer than the TTT;
duration time of satisfying a leaving condition of Location based event 2 is equal to or longer than the TTT;
duration time of satisfying a leaving condition of Event A3 or Event A5 is equal to or longer than the TTT; and
the UE determines that at least one of “the entering condition of Location based event 1, the entering condition of Location based event 2, and the entering condition of Event A3 or Event A5” is not satisfied during the TTT. In other words, if the UE finds that at least one entering condition of these CHO execution conditions has not been satisfied when the TTT expires, the UE determines that the combined CHO execution condition is not satisfied.

In Option 2, a UE considers an event whose entering condition is satisfied during a TTT as “fulfilled” and considers an event whose entering condition is not satisfied during the TTT as “not fulfilled”. In some examples of Option 2, the UE may determine that the CHO execution condition is not satisfied, in each of the following cases:
duration time of satisfying an entering condition of Location based event 1 is shorter than the TTT;
duration time of satisfying an entering condition of Location based event 2 is shorter than the TTT; and
duration time of satisfying an entering condition of Event A3 or Event A5 is shorter than the TTT.

In some embodiments of the subject application, a CHO execution condition associated with a target candidate cell comprises an absolute time of a UE.

Combination Manner 2

In some embodiments of the subject application, a CHO execution condition associated with a target candidate cell may be a combination of a measurement based trigger condition and an absolute time of a UE. For instance, the CHO execution condition associated with the target candidate cell may be named as “the combined CHO trigger condition” and may be one of:
A combination of Event A3 and an absolute time of a UE.
A combination of Event A5 and an absolute time of a UE.

In the combined CHO trigger condition, if a measurement based event is firstly fulfilled and an absolute time of a UE is not met (or a timer does not expire), the UE may consider the target candidate cell as a triggered cell if the absolute time is met (or the timer expires) and the measurement based event is considered as “fulfilled”.

In an example, if a time instance reaches the absolute time and duration time of satisfying an entering condition of Event A3 or Event A5 is equal to or longer than the TTT, the UE may determine that the combined CHO execution condition is satisfied.

In the combined CHO trigger condition, if the absolute time of the UE is firstly met (or a timer expires) while the measurement based event is not fulfilled, the UE may start a new timer to control the CHO execution procedure. If no new timer is introduced, the UE may need to release the corresponding CHO execution procedure. In particular, a measurement report may be triggered. Once an entering condition is met during a TTT within a period, the UE considers the target candidate cell as a triggered cell. Once the new timer expires, the UE stops evaluating the corresponding CHO execution condition. Furthermore, the UE may release the CHO execution condition.

In one example, if a time instance reaches the absolute time and duration time of satisfying an entering condition of Event A3 or Event A5 is shorter than the TTT, the UE may trigger a measurement report procedure.

In another example, if a time instance reaches the absolute time and Event A3 or Event A5 is not satisfied during the TTT, the UE starts a timer. Upon an expiry of the timer, the UE may stop evaluating the CHO execution condition associated with each target candidate cell.

Combination Manner 3

In some embodiments of the subject application, a CHO execution condition associated with a target candidate cell may be a combination of a measurement based trigger condition and a TA based trigger condition. For instance, the CHO execution condition associated with the target candidate cell may be named as “the combined CHO trigger condition” and may be one of:
A combination of Event A3 and TA based event 1.
A combination of Event A3 and TA based event 2.
A combination of Event A5 and TA based event 1.
A combination of Event A5 and TA based event 2.

In Option 1, only if a measurement based event is fulfilled and a TA based event is also fulfilled, the UE considers the target candidate cell as a triggered cell and starts a CHO procedure. In some examples of Option 1, the UE may determine that the combined CHO execution condition is not satisfied, in each of the following cases:
duration time of satisfying a leaving condition of TA based event 1 is equal to or longer than the TTT;
duration time of satisfying a leaving condition of TA based event 2 is equal to or longer than the TTT;
duration time of satisfying a leaving condition of Event A3 or Event A5 is equal to or longer than the TTT; and
the UE determines that at least one of “the entering condition of TA based event 1, the entering condition of TA based event 2, and the entering condition of Event A3 or Event A5” is not satisfied during the TTT. In other words, if the UE finds that at least one entering condition of these CHO execution conditions has not been satisfied when the TTT expires, the UE determines that the combined CHO execution condition is not satisfied.

In Option 2, a UE considers an event whose entering condition is satisfied during a TTT as “fulfilled” and considers an event whose entering condition is not satisfied during the TTT as “not fulfilled”. In some examples of Option 2, the UE may determine that the combined CHO execution condition is not satisfied, in each of the following cases:
duration time of satisfying an entering condition of TA based event 1 is shorter than the TTT;
duration time of satisfying an entering condition of TA based event 2 is shorter than the TTT; and
duration time of satisfying an entering condition of Event A3 or Event A5 is shorter than the TTT.

Combination Manner 4

In some embodiments of the subject application, a CHO execution condition associated with a target candidate cell may be a combination of a measurement based trigger condition and an EA based trigger condition. For instance, the CHO execution condition associated with the target candidate cell may be named as “the combined CHO trigger condition” and may be one of:
A combination of Event A3 and EA based event 1.
A combination of Event A3 and EA based event 2.
A combination of Event A5 and EA based event 1.
A combination of Event A5 and EA based event 2.

In Option 1, only if a measurement based event is fulfilled and an EA based event is also fulfilled, the UE considers the target candidate cell as a triggered cell and starts a CHO procedure. In some examples of Option 1, the UE may determine that the combined CHO execution condition is not satisfied, in each of the following cases:
duration time of satisfying a leaving condition of EA based event 1 is equal to or longer than the TTT;
duration time of satisfying a leaving condition of EA based event 2 is equal to or longer than the TTT;
duration time of satisfying a leaving condition of Event A3 or Event A5 is equal to or longer than the TTT; and
the UE determines that at least one of “the entering condition of EA based event 1, the entering condition of EA based event 2, and the entering condition of Event A3 or Event A5” is not satisfied during the TTT. In other words, if the UE finds that at least one entering condition of these CHO execution conditions has not been satisfied when the TTT expires, the UE determines that the combined CHO execution condition is not satisfied.

In Option 2, a UE considers an event whose entering condition is satisfied during a TTT as “fulfilled” and considers an event whose entering condition is not satisfied during the TTT as “not fulfilled”. In some examples of Option 2, the UE may determine that the combined CHO execution condition is not satisfied, in each of the following cases:
duration time of satisfying an entering condition of EA based event 1 is shorter than the TTT;
duration time of satisfying an entering condition of EA based event 2 is shorter than the TTT; and
duration time of satisfying an entering condition of Event A3 or Event A5 is shorter than the TTT.

Details described in the embodiments as illustrated and shown in FIGS. 1, 2, 4, and 5, especially, contents related to specific operations for handling CHO execution conditions, are applicable for the embodiments as illustrated and shown in FIG. 3. Moreover, details described in the embodiments of FIG. 3 are applicable for all the embodiments of FIGS. 1, 2, 4, and 5.

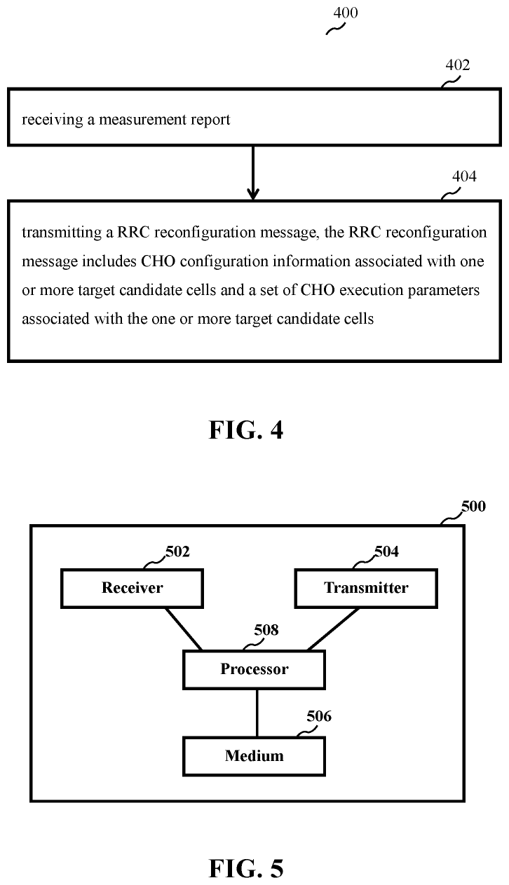

FIG. 4 illustrates an exemplary flow chart of a method for transmitting parameters of CHO execution conditions in accordance with some embodiments of the present application. The embodiments of FIG. 4 may be performed by a BS or a source BS (e.g., a BS 102 illustrated and shown in FIG. 1). Although described with respect to a BS, it should be understood that other devices may be configured to perform a method similar to that of FIG. 4.

In the exemplary method 400 as shown in FIG. 4, in operation 402, a BS receives a measurement report. For example, the BS receives a measurement report from a UE (e.g., UE 101-A and UE 101-B illustrated and shown in FIG. 1).

In operation 404, the BS transmits a RRC reconfiguration message. For example, the BS transmits the RRC reconfiguration message to the UE (e.g., UE 101-A and UE 101-B illustrated and shown in FIG. 1). The RRC reconfiguration message includes CHO configuration information associated with one or more target candidate cells. The RRC reconfiguration message also includes a set of parameters of CHO execution conditions associated with the one or more target candidate cells. In an example, the set of parameters of CHO execution conditions includes a timer to trigger (TTT).

According to some embodiments, the set of parameters of CHO execution conditions includes a distance hysteresis parameter and a distance offset. These parameters may be used for Location based event 1. The distance offset is cell specific and may be associated with “a measurement object of the UE” or “a satellite”.

According to some embodiments, the set of parameters of CHO execution conditions includes a distance hysteresis parameter and two distance thresholds. These parameters may be used for Location based event 2.

According to some embodiments, the set of parameters of CHO execution conditions includes a TA hysteresis parameter and a TA offset. These parameters may be used for TA based event 1. The TA offset is cell specific and may be associated with “a measurement object of the UE” or “a satellite”.

According to some embodiments, the set of parameters of CHO execution conditions includes a TA hysteresis parameter and two TA thresholds. These parameters may be used for TA based event 2.

According to some embodiments, the set of parameters of CHO execution conditions includes an EA hysteresis parameter and an EA offset. These parameters may be used for EA based event 1. The EA offset is cell specific and may be associated with “a measurement object of the UE” or “a satellite”.

According to some embodiments, the set of parameters of CHO execution conditions includes an EA hysteresis parameter and two EA thresholds. These parameters may be used for EA based event 2.

According to some embodiments, the BS further transmits a mapping table including one or more entries. Each entry may include at least one of:
a mapping association between “distance information of the UE” and “a timing advance (TA) value between the UE and the source cell”. The UE (e.g., UE 101-A and UE 101-B illustrated and shown in FIG. 1) may calculate the distance information based on location information and ephemeris information of the UE; and
a mapping association between “the distance information of the UE” and “a TA value between the UE and the target candidate cell”.

Details described in the embodiments as illustrated and shown in FIGS. 1-3 and 5, especially, contents related to specific operations for handling CHO execution conditions and combination manners of CHO execution conditions, are applicable for the embodiments as illustrated and shown in FIG. 4. Moreover, details described in the embodiments of FIG. 4 are applicable for all the embodiments of FIGS. 1-3 and 5.

FIG. 5 illustrates an exemplary block diagram of an apparatus according to some embodiments of the present application. In some embodiments of the present application, the apparatus 500 may be a UE, which can at least perform the method illustrated in FIG. 3. In some embodiments of the present application, the apparatus 500 may be a BS, which can at least perform the method illustrated in FIG. 4.

As shown in FIG. 5, the apparatus 500 may include at least one receiver 502, at least one transmitter 504, at least one non-transitory computer-readable medium 506, and at least one processor 508 coupled to the at least one receiver 502, the at least one transmitter 504, and the at least one non-transitory computer-readable medium 506.

Although in FIG. 5, elements such as the at least one receiver 502, the at least one transmitter 504, the at least one non-transitory computer-readable medium 506, and the at least one processor 508 are described in the singular, the plural is contemplated unless limitation to the singular is explicitly stated. In some embodiments of the present application, the at least one receiver 502 and the at least one transmitter 504 are combined into a single device, such as a transceiver. In certain embodiments of the present application, the apparatus 500 may further include an input device, a memory, and/or other components.

In some embodiments of the present application, the at least one non-transitory computer-readable medium 506 may have stored thereon computer-executable instructions which are programmed to implement the operations of the methods, for example as described in view of FIG. 3 or FIG. 4, with the at least one receiver 502, the at least one transmitter 504, and the at least one processor 508.

Those having ordinary skills in the art would understand that the operations of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.”

1-55. (canceled)

56. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method, the method comprising:
receiving a radio resource control (RRC) reconfiguration message, wherein the RRC reconfiguration message includes conditional handover (CHO) configuration information associated with one or more target candidate cells and a set of parameters of CHO execution conditions associated with the one or more target candidate cells;
evaluating one or more CHO execution conditions associated with each of the one or more target candidate cells;
determining whether a CHO execution condition associated with a target candidate cell is satisfied; and
in response to satisfying the CHO execution condition, performing a CHO procedure from a source cell to the target candidate cell.

57. The apparatus of claim 56, wherein at least one of the source cell and the target candidate cell is a non terrestrial network (NTN) cell.

58. The apparatus of claim 56, wherein the CHO execution condition comprises a first location based trigger condition, and the first location based trigger condition is:
a first distance between a user equipment (UE) and the source cell is offset greater than a second distance between the UE and the target candidate cell.

59. The apparatus of claim 56, wherein the CHO execution condition comprises a second location based trigger condition, and the second location based trigger condition is at least one of:
a first distance between a user equipment (UE) and the source cell is greater than a first distance threshold; and
a second distance between the UE and the target candidate cell is less than a second distance threshold.

60. The apparatus of claim 59, wherein the set of parameters of CHO execution conditions includes a second distance hysteresis parameter, the first distance threshold, and the second distance threshold, wherein the second location based trigger condition comprises a second distance entering condition of the CHO procedure, and wherein the second distance entering condition comprises one of:
a difference between the first distance and the second distance hysteresis parameter is greater than the first distance threshold; and
a sum of the second distance and the second distance hysteresis parameter is less than the second distance threshold.

61. The apparatus of claim 60, further comprising:
determining that a distance leaving condition of the CHO procedure is satisfied in response to at least one of:
a sum of the first distance and the first distance hysteresis parameter is less than the sum of the second distance and the distance offset;
a sum of the first distance and the second distance hysteresis parameter is less than the first distance threshold; and
a difference between the second distance and the second distance hysteresis parameter is greater than the second distance threshold.

62. The apparatus of claim 58, wherein the set of parameters of CHO execution conditions includes a timer to trigger (TTT), and the CHO execution condition is one of:
a combination of the measurement based trigger condition and the first location based trigger condition; and
a combination of the measurement based trigger condition and the second location based trigger condition.

63. The apparatus of claim 62, further comprising:
in response to duration time of satisfying an entering condition of the second location based trigger condition being equal to or longer than the TTT and duration time of satisfying an entering condition of the measurement based trigger condition being equal to or longer than the TTT, determining that the CHO execution condition is satisfied.

64. The apparatus of claim 62, further comprising:
determining that the CHO execution condition is not satisfied in response to one of:
duration time of satisfying a leaving condition of the first location based trigger condition being equal to or longer than the TTT;
duration time of satisfying a leaving condition of the second location based trigger condition being equal to or longer than the TTT;
duration time of satisfying a leaving condition of the measurement based trigger condition being equal to or longer than the TTT; and
determining that at least one of the entering condition of the first location based trigger condition, the entering condition of the second location based trigger, and the entering condition of the measurement based trigger condition is not satisfied during the TTT.

65. The apparatus of claim 56, wherein the set of parameters of CHO execution conditions includes an absolute time of a user equipment (UE).

66. The apparatus of claim 56, further comprising:
upon successfully accessing to the target candidate cell, removing the CHO configuration information and the set of parameters of CHO execution conditions.

67. An apparatus, comprising:
at least one non-transitory computer-readable medium having stored thereon computer-executable instructions;
at least one receiving circuitry;
at least one transmitting circuitry; and
at least one processor coupled to the at least one non-transitory computer-readable medium, the at least one receiving circuitry and the at least one transmitting circuitry,
wherein the computer-executable instructions cause the at least one processor to implement a method, the method comprising:
receiving a measurement report; and
transmitting a radio resource control (RRC) reconfiguration message,
wherein the RRC reconfiguration message includes conditional handover (CHO) configuration information associated with one or more target candidate cells and a set of parameters of CHO execution conditions associated with the one or more target candidate cells.

68. The apparatus of claim 67, wherein the set of parameters of CHO execution conditions includes a first distance hysteresis parameter and a distance offset.

69. The apparatus of claim 67, wherein the set of parameters of CHO execution conditions includes a second distance hysteresis parameter, a first distance threshold, and a second distance threshold.

70. The apparatus of claim 67, wherein the set of parameters of CHO execution conditions includes a first TA hysteresis parameter and a TA offset.

71. The apparatus of claim 67, wherein the set of parameters of CHO execution conditions includes a second TA hysteresis parameter, a first TA threshold, and a second TA threshold.

72. The apparatus of claim 67, wherein the set of parameters of CHO execution conditions includes a first EA hysteresis parameter and an EA offset.

73. The apparatus of claim 67, wherein the set of parameters of CHO execution conditions includes a timer to trigger (TTT).

74. The apparatus of claim 67, further comprising:
transmitting a mapping table including one or more entries, wherein the one or more entries include at least one of:
a mapping association between distance information of a user equipment (UE) and a timing advance (TA) value between the UE and the source cell; and
a mapping association between the distance information of the UE and a TA value between the UE and a target candidate cell.

75. A method, comprising:
receiving a radio resource control (RRC) reconfiguration message,
wherein the RRC reconfiguration message includes conditional handover (CHO) configuration information associated with one or more target candidate cells and a set of parameters of CHO execution conditions associated with the one or more target candidate cells;
evaluating one or more CHO execution conditions associated with each of the one or more target candidate cells;
determining whether a CHO execution condition associated with a target candidate cell is satisfied; and
in response to satisfying the CHO execution condition, performing a CHO procedure from a source cell to the target candidate cell.
